(19) United States
(12) Patent Application Publication
(10) Pub. No.: US 2026/0208197 A1
(43) Pub. Date: Jul. 23, 2026

(54) RFID TAG FOR SAMPLE RACK

(71) Applicant: Azenta UK LTD, Burlington, MA (US)

(72) Inventors: Wael Gorma, Cambridgeshire (GB); Oluyomi Simpson, Cambridgeshire (GB); Yichuang Sun, Cambridgeshire (GB); Neil Benn, Cambridgeshire (GB); Karem Terry, Cambridgeshire (GB); Paul Darlow, Cambridgeshire (GB)

(21) Appl. No.: 19/141,553

(22) PCT Filed: Dec. 18, 2023
(86) PCT No.: PCT/EP2023/086325

§ 371 Date: Jun. 20, 2025

(30) Foreign Application Priority Data
Dec. 20, 2022 (GB) 2219249.6

(51) Int. Cl. B01L 3/00; G06K 7/10; G06K 7/14; G06K 19/07

(52) U.S. Cl. CPC B01L 3/5453; G06K 7/10297; G06K 7/10386; G06K 7/1413; G06K 19/0723

(57) ABSTRACT

The disclosure relates to a method of automatically storing information from a plurality of sample holders held in a sample rack, each of the sample holders having an individual barcode thereon, in an RFID tag affixed to the sample rack using an image capture device. The image capture device captures an image of the 2D barcodes, obtains data associated with each barcode based on the image, and communicates with the RFID tag to store the data thereon. The disclosure includes a mechanical clip for affixing the RFID tag to the sample rack in a manner that is robust when cooled to cryogenic temperatures. Also disclosed is a handheld scanning device that can be used to access information stored on the RFID tag.

### FIELD OF THE INVENTION

The invention generally relates to sample storage, including a sample rack with an affixed RFID tag, as well as a mechanical device for affixing the RFID tag.

### BACKGROUND TO THE INVENTION

Automated and robotic systems are widely used in research and analysis laboratories in the pharmaceutical, biotechnology and veterinary industries, where large numbers of biological samples such as blood and other human/animal fluids, biological drug candidates or small molecule libraries in powder or liquid form are handled. Some such samples require storage at low, for example cryogenic, temperatures. For example, biobanking can require temperatures of approximately −150° C.

Increasingly, samples are contained within sample holders (such as test tubes or vials) that are labelled with unique 2D barcodes generally placed on the base of the tube in order to identify each individual sample. The barcode acts as an identifier to allow a researcher to access information about the sample from a file or database with ease.

Such sample holders are commonly held in racks that allow samples to be easily transported and enable the barcodes on the base of the sample holders to be read. In automated systems, machine vision is used to capture images of the base of a rack and analyse the images to determine the barcode on each sample holder. In any machine vision application, the quality of the image that is captured is vital to the success of the resulting analysis.

FIG. 1A shows the underside of an exemplary sample rack 100 containing sample holders 102. In this case, the sample rack contains 96 sample holders. FIG. 1B illustrates a 2D barcode 104 on the base of one of the sample holders 102. The barcode 104 uniquely identifies the sample contained in the sample holder 102. It will be appreciated that the number of sample holders may be a number other than 96, and that the barcodes 104 can be positioned elsewhere, such as on top of the tubes 102. It is noted that the sample rack 100 itself may have an associated barcode, such as a 1D barcode, for uniquely identifying the sample rack.

In order to capture an image, an image capture device is required. Known image capture devices contain an image sensor or sensors which may for example be a charged couple device (CCD) or complementary metal-oxide-semiconductor (CMOS) device.

In a camera based device one or more CCD or CMOS image sensors are fixed within the device.

FIG. 2 illustrates a known image capture device 200 which uses a single camera 202 to obtain an image of a sample rack 100 holding sample holders 102 labelled with barcodes. FIG. 3 illustrates a further known image capture device 300 wherein the beam path from the sample rack 100 to the camera 202 contains a mirror 302, bending the beam path and allowing a reduction in the total height of the device. The sample rack 100 and sample holders 102 may, for example, be the same as those illustrated in FIGS. 1A and 1B.

Cryogenic and other low temperature sample storage can present a problem for such image-based recognition, as ice can accumulate on sample holders that obscures the barcodes, preventing simple identification of the contained sample. Removing this ice without warming or otherwise endangering the samples can waste significant time and effort.

### SUMMARY OF THE INVENTION

The inventors have explored non-image-based methods for sample recognition. In particular, the application of an individual RFID tag on each sample holder to identify the respective sample holder's contents. This would allow identification of the sample within even if the barcode is obscured by ice.

The inventors have recognised several difficulties with the application of RFID tags to cryogenic sample storage. The cost of providing an RFID tag for each container, of which there could be e.g. 96 in one sample rack, is prohibitive. Additionally, RFID tags typically cannot survive direct exposure to coolants such as liquid nitrogen (such as during an accidental splash), since differential thermal contraction between the chip and antenna of the RFID tag exerts mechanical stress which causes the chip and the antenna to disjoint; such differential contraction will also occur for any adhesive used to bond the RFID tag to the sample holder causing further breakage. Further, given the small size of typical sample holders (such as test tubes), each RFID tag must be extremely small, limiting the amount of information that can be stored on each tag. Another issue is that reading the tag placed on each sample holder is likely to require the sample rack to be removed from storage so that a reader can be moved into close proximity with each sample holder; this removal from storage is inconvenient and risks causing damage to samples.

The present invention therefore provides means of identifying sample holders using RFID that overcomes the issues mentioned above.

According to one aspect of the present disclosure there is provided a method of storing information from a plurality of sample holders held in a sample rack, each of the sample holders having an individual barcode thereon, wherein there is an RFID tag affixed to the sample rack, the method performed by a processor of an image capture device and comprising: receiving an image of the barcodes from at least one camera of the image capture device; obtaining data associated with each barcode based on the image; establishing communication with the RFID tag via an RFID reader/writer of the image capture device; and transmitting, via the RFID reader/writer, the data associated with each barcode to the RFID tag for storage thereon.

One advantage of this method is that only a single RFID tag is required, attached to the sample rack, rather than an RFID tag for each individual sample holder, thereby reducing the number of components in the system.

Additionally, embodiments of the present disclosure enable the use of a somewhat larger RFID tag with correspondingly increased memory.

Furthermore, having an RFID tag attached to e.g. the side of the rack allows the tag to be accessed more easily by a (e.g. handheld) reading device. There is also no possibility of conflicting signals being detected from a multitude of RFID tags being attached to each individual sample holder.

Obtaining data associated with each barcode may comprise analysing the image to extract the data.

Obtaining data associated with each barcode may comprise transmitting the image to a host computer; and receiving the data from the host computer.

The RFID reader/writer may communicate with the RFID tag via near-field communication (NFC).

NFC has the advantage of allowing more sophisticated bidirectional communication between the tag and a reader compared to conventional RFID. For example, the reader can retrieve information relating to a specific sample holder.

The method may further comprise compressing the data associated with each barcode prior to said transmitting. This advantageously allows information associated with more sample holders to be fitted on a given RFID tag.

The data associated with each barcode may comprise a unique identifier of each sample holder.

The data associated with each barcode may comprise a location of each sample holder within the sample rack.

The method may further comprise adding metadata to the data associated with each barcode prior to said transmitting, such that the metadata and the data are stored on the RFID tag.

The metadata may comprise a time stamp indicating a time at which the image was captured.

The method may further comprise using a handheld scanning device to read the data from the RFID tag.

According to another aspect of the present disclosure, there is presented an image capture device for storing information from a plurality of sample holders held in a sample rack, each of the sample holders having an individual barcode thereon, wherein there is an RFID tag affixed to the sample rack, the image capture device comprising: at least one camera configured to capture an image of the sample rack; an RFID reader/writer configured to establish communication with the RFID tag; and a processor configured to obtain data associated with each barcode based on the image, and transmit the data, via the RFID reader/writer, to the RFID tag for storage thereon.

The processor of the image capture device may be configured to obtain the data and by analysing the image to extract the data.

The processor of the image capture device may be configured to obtain the data by transmitting the image to a host computer and receiving the data from the host computer.

The use of such a device has the advantage that the RFID tag may be populated automatically following the capture of a single photograph. If desired, this may be accomplished without human involvement (except in placing the rack on the device). Subsequently, there is no need to image the barcodes again until a change is made to the sample holders stored in the rack (such as a rearrangement, or the removal or addition of some sample holders).

The image capture device may further comprise an enclosure comprising a transparent window which, in use, is adjacent to the sample holder rack.

The at least one camera may be mounted within the enclosure.

The image capture device may further comprise a lighting arrangement mounted within the enclosure, the lighting arrangement comprising at least one light source to illuminate the sample rack through the transparent window.

The image capture device may further comprise a mirror in an optical path between the at least one camera and the transparent window, the mirror arranged to relay light rays reflecting from the sample rack to the at least one camera.

The use of a mirror has the advantage that the optical path to the at least one camera may be bent, such that the overall size of the image capture device may be reduced.

The camera, the lighting arrangement, and the mirror may be non-moveable.

The image capture device may further comprise a 1D barcode scanner operable to read a 1D barcode on the sample rack, wherein the 1D barcode identifies the sample rack.

An advantage of this feature is that the sample rack itself may be identified using the 1D barcode.

The RFID reader/writer may further comprise an antenna positioned such that, in use, the antenna is adjacent to the RFID tag.

The RFID reader/writer may comprise a power regulator to adapt a power output of the antenna via a dynamic power output module. This feature has the advantage of avoiding unnecessary power consumption. In particular, the dynamic power output module allows the field strength emitted by the antenna to be adjusted depending on the signal strength of the response received from the RFID tag. This ensures optimal communication with the tag even if environmental conditions change (for example, due to cooling to cryogenic temperatures).

The RFID reader/writer may be further configured to control a transmission frequency of the antenna by using one or more variable capacitors to implement automatic antenna tuning. This feature has the advantage that the transmission frequency of the antenna can be adjusted to account for any alterations in the frequency of the RFID tag caused by changes in temperature (e.g. by cooling to cryogenic temperatures). This allows the RFID tag to operate at cryogenic temperatures while still being functional at room temperatures of around 25° C.

The RFID reader/writer may comprise a noise suppression receiver to implement continuous signal level scaling. This feature has the advantage of reducing the risk of errors when communicating with the RFID tag.

The RFID reader/writer may comprise an active wave shaping switch. This feature has the advantage of reducing the risk of errors when communicating with the RFID tag, in particular by reducing over-and under-shoots of the digital carrier signal transmitted to the RFID tag.

The RFID reader/writer may comprise one or more further antennas. This feature has the advantage of allowing RFID coverage over a wider area, such that multiple possible locations of the RFID tag can be covered. For example, if there are several places where the RFID tag may be attached to the sample rack, or if the sample rack has several possible orientations, one antenna can be provided for each possibility.

According to a further aspect of the present disclosure, there is presented a computer program product for storing information from a plurality of sample holders held in a sample rack, each of the sample holders having an individual barcode thereon, wherein there is an RFID tag affixed to the sample rack, the computer program product comprising code embodied on a computer readable medium and configured so as when executed on the processor of the image capture device to perform any of the methods described herein.

According to a further aspect of the present disclosure, there is provided an assembly comprising: a sample rack for holding a plurality of sample holders, each of the sample holders having an individual barcode thereon; and an RFID tag for affixing to the sample rack.

The advantages of attaching a single RFID tag to the sample rack, as opposed to attaching an individual RFID tag to each sample holder, are noted above.

The RFID tag may comprise a chip and an antenna, and the chip and the antenna may be attached by direct bonding.

An advantage of this feature is that there is no adhesive material between the chip and the antenna to undergo differential thermal expansion. The RFID tag is therefore more able to survive sudden changes in temperature without breaking.

The RFID tag may comprise a memory, which may comprise ferroelectric random-access memory (FRAM) storage. FRAM has the advantage of providing increased capacity for data storage, such that the data associated with the entire contents of a full sample rack can fit onto a single RFID tag while keeping the RFID tag small enough to fit onto a sample rack. Additionally, FRAM has the advantage of radiation hardness, allowing the RFID tag to retain stored information even following gamma ray sterilisation. This allows the RFID tag to be used in medical and healthcare applications. FRAM also features anti-collision capability, meaning that if several sample racks with fitted tags are stored in close proximity there is less risk of addressing the wrong tag.

The RFID tag may be configured to communicate via near-field communication (NFC).

The RFID tag may be passively powered via energy harvesting. An advantage of this feature is that the RFID tag does not require a power source such as a battery, which may be damaged by exposure to cryogenic temperatures.

A footprint area of the RFID tag may be less than 160 mm² . An advantage of this feature is that the RFID tag may be more easily fit onto a conventional sample rack without making the rack more difficult to store.

The assembly may further comprise a mechanical device for affixing the RFID tag to the sample rack. An advantage of this feature is that a mechanical device may be more resistant to sudden changes in temperature than, for example, an adhesive.

The mechanical device may affix the RFID tag to the sample rack without any adhesive. An advantage of this feature is the prevention of differential thermal contraction between the tag and an adhesive on cooling to cryogenic temperatures. Such differential contraction may cause the adhesive and/or the tag to break.

The sample rack may comprise a recess configured to be engaged by the mechanical device supporting the RFID tag.

The mechanical device may comprise an RFID tag clip.

The RFID tag clip may comprise: an RFID tag supporting portion; and a deformable member configured to move between a compressed state and an extended state, wherein the deformable member is biased towards the extended state.

The deformable member may be configured to bend around a point partway along a length of the deformable member.

The deformable member may be defined by a V-shaped member.

The RFID tag supporting portion may define a slot for receiving the RFID tag.

The slot may be defined by a U-shaped member of the RFID tag clip.

The RFID tag clip may comprise a bent extrusion of metal. An advantage of this feature is that a single piece of metal is highly resilient to changing temperature, and will not be damaged by cooling to cryogenic temperatures.

A fist portion of the extrusion may be bent into a V-shape to define the deformable member, and a second potion of the extrusion may be bent into a U-shape to define the RFID tag supporting portion.

The RFID tag may be supported by the RFID tag supporting portion.

The RFID tag may be encapsulated by a protective enclosure, which may also be supported by the RFID tag supporting portion. This feature has the advantage of thermally insulating the RFID tag, such that a sudden change in ambient temperature results in a more gradual change in the temperature of the RFID tag. This reduces the chance of the RFID tag breaking during cooling.

The protective enclosure may comprise a case with a fold line, such that the case is able to close and receive the RFID tag therein.

When the RFID tag clip is inserted into the recess, the recess may hold the deformable member in the compressed state, such that the deformable member is urged against walls of the recess, thereby holding the RFID tag clip in place. This feature has the advantage that the exact size of the recess may not matter. Provided that the recess is less wide that the width of the RFID tag clip when the deformable member is fully extended, the deformable member will exert a force capable of holding the RFID tag clip in place. The RFID tag clip can therefore be made compatible with a variety of existing commercially available sample racks.

According to a further aspect of the present disclosure, there is presented a system comprising: the assembly as described above; and a handheld scanning device comprising a processor configured to: transmit a probing signal to the RFID tag; receive a return signal from the RFID tag, the return signal comprising data stored on the RFID tag; and output the data.

The handheld scanner provides the advantage of easily and conveniently checking the contents of the sample rack, without for example needing to remove the rack from storage.

Outputting the data may comprise causing a display of the handheld scanning device to display the data.

Outputting the data may comprise transmitting the data to another device.

The processor may be further configured to control a barcode reader of the handheld scanner to: capture an image of the barcodes; and analyse the image to extract data associated with each barcode. This feature has the advantage that if the contents of the rack are suspected to have changed, the handheld scanner can be used to scan the barcodes on each sample holder to identify which sample holders are present. The processor may be further configured to control a power output of the handheld scanning device using a dynamic power output module.

The processor may be further configured to control a transmission frequency of the handheld scanning device using an automatic antenna tuning module.

The processor may be further configured to control an output of the handheld scanning device using a noise cancellation module.

The processor may be further configured to control the handheld scanning device using an active wave shaping module.

The handheld scanning device may be a mobile phone.

According to a further aspect of the present disclosure, there is presented an RFID tag clip, the RFID tag clip comprising: an RFID tag supporting portion; and a deformable member configured to move between a compressed state and an extended state, wherein the deformable member is biased towards the extended state.

As noted above, the RFID tag clip has the advantage of being able to support an RFID tag without damage resulting from extreme changes in temperature.

The RFID tag supporting portion may define a slot for receiving an RFID tag.

The slot may be defined by a U-shaped member of the RFID tag clip.

The RFID tag clip may further comprise an RFID tag supported by the RFID tag supporting portion.

The RFID tag may be encapsulated by a protective enclosure, wherein the protective enclosure is also supported by the RFID tag supporting portion.

According to a further aspect of the present disclosure, there is presented a method of affixing an RFID tag to a sample rack, the method comprising: inserting the RFID tag into an RFID tag clip; and affixing the RFID tag clip to the sample rack.

The sample rack may comprise a recess, and affixing the RFID tag clip to the sample rack may comprise inserting the RFID tag clip into the recess.

Affixing the RFID tag clip to the sample rack may comprise: inserting the RFID tag clip into an applicator; positioning the applicator at an entrance of the recess; and operating the applicator to dispense the RIFD tag clip into the recess.

Positioning the applicator may comprise resting one or more teeth of the applicator on an edge of the recess.

Operating the applicator may comprise pushing a propelling device of the applicator to dispense the RFID tag clip into the recess.

The RFID tag clip may comprise: an RFID tag supporting portion; and a deformable member configured to move between a compressed state and an extended state, wherein the deformable member is biased towards the extended state.

When the RFID tag clip is inserted into the recess, the recess may hold the deformable member in the compressed state, such that the deformable member is urged against walls of the recess, thereby holding the RFID tag clip in place. As noted above, this feature has the advantage that the RFID tag clip can be affixed to sample racks with varying sizes of recess.

A handheld applicator for dispensing a clip into a recess, the applicator comprising: a shaft comprising an open end operable to receive a clip; a blade contained within the shaft, the blade able to move linearly along the shaft so as to push the clip received by the open end, thereby dispensing the clip from the open end; a knob external to the shaft and attached to the blade, such that a user is able to move the blade by pushing the knob; and one or more teeth adjacent to the open end, wherein the teeth are operable to rest on an edge of the recess, such that when the teeth are resting on the edge of the recess, the open end adopts a position suitable for the clip to be dispensed into the recess.

The shaft may further comprise a closed end opposing the open end.

The knob may be attached to the blade through a slot in a surface of the shaft, such that the knob is able to move linearly from one end of the slot to an opposite end of the slot, thereby moving the blade between two end positions.

The slot is configured such that moving the blade to one of the end positions allows the clip to be inserted into the open end, and moving the blade to the other end position dispenses the clip from the open end.

The slot may be disposed on a first side of the shaft opposing a second side of the shaft, wherein the teeth are disposed on the second side of the shaft.

It will be appreciated that the functionality of the devices we describe may be divided across several modules. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), etc. The, or each processor may include one or more processing cores with each core configured to perform independently. The, or each processor may have connectivity to a bus to execute instructions and process information stored in, for example, a memory.

The invention further provides processor control code to implement the above-described systems and methods, for example on a general purpose computer system or on a digital signal processor (DSP). The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C or Python, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1A shows the underside of an exemplary sample rack;

FIG. 1B shows the underside of an exemplary sample holder featuring a barcode;

FIG. 2 shows a block diagram of an existing image capture device for a sample rack containing sample holders;

FIG. 3 shows a further existing image capture device;

FIG. 4 shows a block diagram of an image capture device and a sample rack, wherein the sample rack is fitted with an RFID tag;

FIG. 5 is a flow chart of a process for storing information from sample holder barcodes on an RFID tag;

FIG. 6 shows the underside of an exemplary sample rack featuring an RFID tag inserted into a recess;

FIG. 7 is a drawing of an RFID tag clip;

FIG. 8 is a drawing of a protective enclosure to be used with an RFID tag clip;

FIG. 9 is a block diagram of a handheld scanner used to read the contents of an RFID tag inserted into a sample rack;

FIG. 10a shows an applicator for dispensing a clip into a recess; and

FIG. 10b shows an exploded view of the applicator of FIG. 10a.

### DETAILED DESCRIPTION

Embodiments will now be described by way of example only.

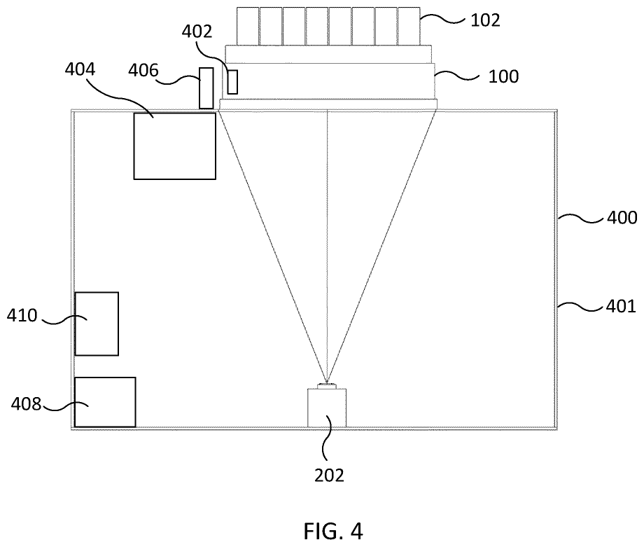

FIG. 4 shows an image capture device 400 according to an embodiment of the present disclosure. The image capture device 400 comprises a camera 202, an RFID reader/writer, and a processor 408. The RFID reader/writer comprises an RFID module 404. The camera 202, RFID module 404, and processor 408 may be housed within an enclosure 401.

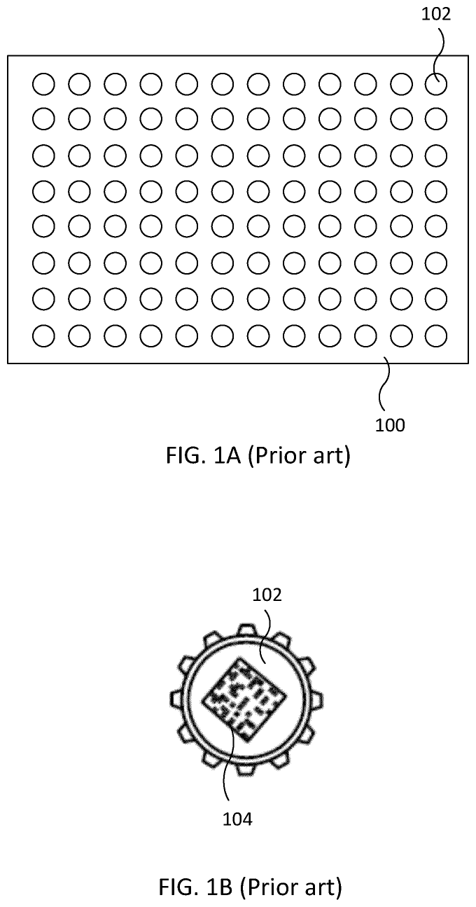

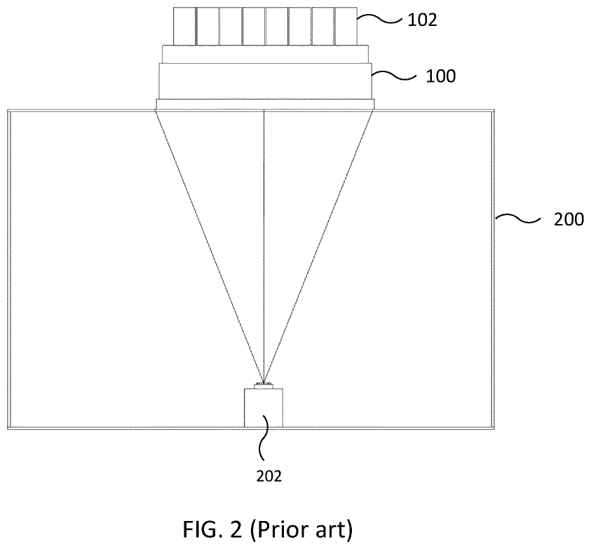

The camera 202 is operable to take images of a sample rack 100 containing sample holders 102, with each sample holder having an individual barcode 104 thereon as shown in FIG. 1B. An RFID tag 402 is affixed to (or within) the sample rack 100. The RFID reader/writer is operable to communicate with the RFID tag 402, for example via near-field communication (NFC), which operates at 13.56 MHz. It will be appreciated that the RFID reader/writer may communicate with the RFID tag 402 using a radio frequency protocol other than NFC.

It is important to note that only a single RFID tag 402 is used for a single sample rack 100, and the RFID tag 402 is attached to the rack itself, not to any of the sample holders 102. This is preferable to, for example, attaching an individual RFID tag to each sample holder 102, for several reasons. For example, it is not economical to provide 96 RFID tags for a rack with 96 sample holders; providing only a single RFID tag 402 is much cheaper and reduces complexity of the system. Additionally, the single RFID tag 402 can be larger than the maximum possible size of an RFID tag on a single sample holder, allowing for increased storage. Furthermore, it is easier to access and communicate with an RFID tag 402 affixed to the rack 100, for example to one side of the rack 100 as shown in FIG. 4, rather than accessing e.g. a tag affixed to a sample holder in the middle of the rack 100. Additionally, the use of 96 tags would present significant issues of tag collision, interference, and cross-talk, as learning the contents of a specific sample holder 102 would require isolating one of 96 signals. This issue is eliminated by the use of a single tag 402 for an entire rack 100.

NFC generally has the advantage of allowing more sophisticated two-way communication between the RFID reader/writer and the RFID tag 402 than can be accomplished by a conventional RFID tag. For example, a conventional RFID tag may broadcast only a single identification number. As described below, the RFID tag 402 is intended to allow the storage and retrieval of information (payloads of data) identifying the contents of the sample holders 102 in the sample rack 100. It is therefore helpful to be able to e.g. query individual entries in the memory of the RFID tag 402 regarding individual sample holders 102. This can be accomplished using NFC.

Additionally, NFC can be configured to allow for communication over a slightly larger distance than conventional RFID technology. For example, communication protocol ISO 15693 allows for “close vicinity” communication rather than “close proximity” communication. The use of a protocol such as ISO 15693 may be useful if, for example, frost build-up prevents reaching close proximity with the RFID tag 402.

In some embodiments, the RFID reader/writer may further comprise an antenna 406 for communicating with the RFID tag 402. The antenna 406 may be on the outside of the enclosure 401, positioned such that the antenna 406 is adjacent to the RFID tag 402 when the sample rack 100 is placed on the image capture device 400 in a particular expected configuration. This facilitates communication by, for example, NFC, which requires a certain proximity between transmitter and receiver. The RFID module 404 may be positioned with the enclosure 401 and connected to the antenna 406, together comprising the RFID reader/writer. Alternatively, the antenna 406 may be an integral part of the RFID module 404. In this case, the RFID module 404 may be positioned outside the enclosure such that the antenna 406 is adjacent to the RFID tag 402.

The RFID reader/writer may have various features or modules that improve the performance of the antenna 406, and communication with the RFID tag 402 more generally.

For example, the RFID reader/writer may comprise a power regulator for automatic gain control to adapt a power output of the antenna 406, a process referred to as dynamic power output. For example, the RFID reader/writer may adjust the power output of the antenna 406 until the return signal received from the RFID tag 402 is within an acceptable range. This ensures that sufficient power is used to allow efficient communication, but avoids wasting excess power unnecessarily.

As a further example, the RFID reader/writer 404 may comprise one or more variable capacitors that are used to control the transmission frequency of the antenna 406, a process called automatic antenna tuning. This is useful if, for example, the frequency of the RFID tag 402 is changed when the ambient temperature changes, for example during cooling to cryogenic temperatures, as the RFID reader/writer 404 can adjust the frequency of the antenna 406 to correspond, ensuring optimum tuning and allowing reception of a high quality signal in a changing environment. In particular, automatic antenna tuning enables the RFID tag to operate equally well at room temperature around 25° C., and at cryogenic temperatures.

As a further example, the RFID reader/writer 404 may comprise a noise suppression receiver able to implement continuous signal level scaling. This allows the filtering of the return signal from the RFID tag 402 to remove background noise, maximising Signal to Noise ratio (SNR) and allowing reception in a noisy environment.

As a further example, the RFID reader/writer may comprise an active wave shaping switch, which improves the fidelity of signals transmitted to the RFID tag 402 in particular by reducing over-and under-shoots in the digital carrier signal.

In some embodiments, the RFID reader/writer may comprise more than one antenna 406. In such embodiments, the RFID module 404 may comprise a multiplexer for communicating with the antennas 406.

Multiple antennas 406 may be desirable if, for example, there are several different locations on the sample rack 100 where the RFID tag 402 may be affixed. Providing an antenna 406 adjacent to each of these possible locations may allow for efficient communication no matter where the RFID tag 402 is affixed (or with multiple different sample racks 100, each of which having the RFID tag 402 affixed in a different location).

Additionally, multiple antennas 406 may advantageously allow the sample rack 100 to be placed in any of several orientations relative to the image capture device 400 while still allowing communication between the RFID tag 402 and the RFID reader/writer.

In the embodiment of FIG. 4, the sample rack 100 is placed on top of the image capture device during use. This generally corresponds to the case where barcodes 104 are present on the lower surface of each sample holder 102, as shown in FIG. 1. However, there are other possibilities. For example, each barcode 104 may be on top of the respective sample holder 102, in which case the sample rack 100 may be placed underneath the image capture device 400 during use.

The image capture device 400 may comprise a transparent window in the enclosure 401 next to which the sample rack 100 is placed. The transparent window affords the camera 102 a view of the barcodes 104. As shown in FIG. 4, the sample rack 100 may be placed on top of the transparent window such that a lower surface of the sample rack 100 is in contact with an upper surface of the transparent window.

Although not illustrated in FIG. 4, the enclosure 401 may further contain a lighting arrangement to illuminate the sample rack 100 through the transparent window, so that the camera 202 is able to capture a clear image of the barcodes 104.

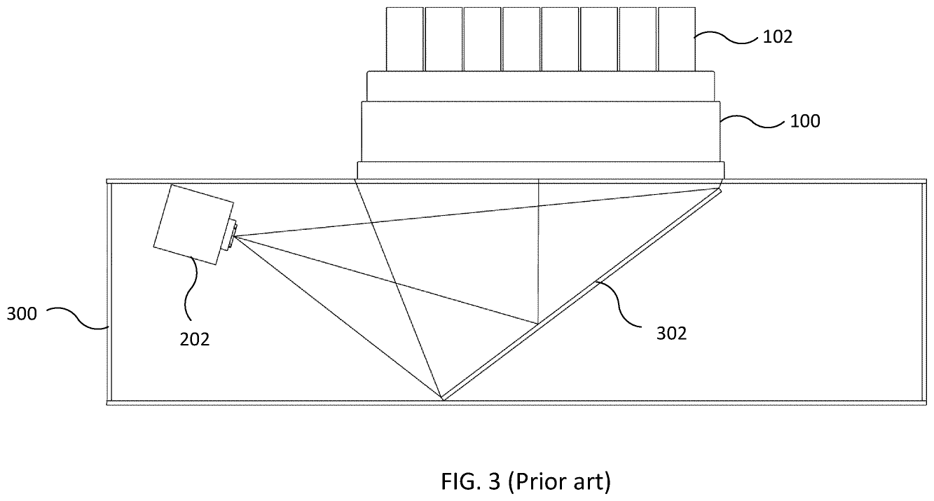

The height of the image capture device may be reduced using a mirror 302 in the beam path between the sample rack 100 and the camera 202, as illustrated in FIG. 3.

The image capture device 400 may output any captured images to a separate host computer for processing. Alternatively, the processing steps described below may be carried out on the processor 408 of the image capture device.

It is generally envisioned that the camera 202 is able to capture a single image showing all of the sample holders 102 in the sample rack 100, without the need for any kind of scanning motion. Where this is the case, the camera 202, lighting arrangement, and/or mirror 302 as described above, may be in fixed positions and consequently non-moveable during operation of the image capture device 400.

It is noted that the image capture device 400 may further comprise a 1D barcode scanner 410 for scanning a 1D barcode that uniquely identifies the sample rack 100, in addition to the barcodes 104 that identify each of the sample holders 102.

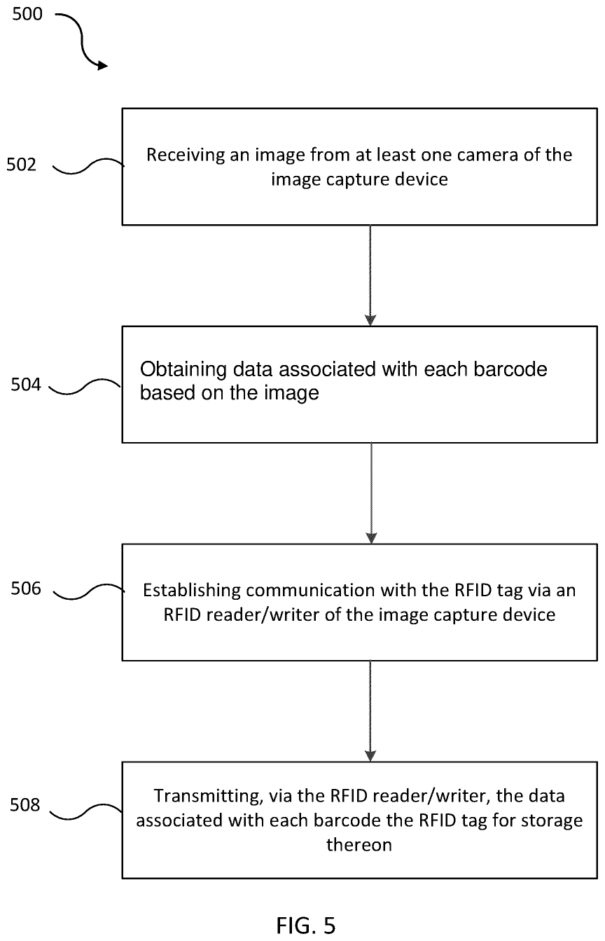

FIG. 5 shows an example of a method 500 that may be carried out by the processor 408 of the image capture device 400.

At step 502, the processor 408 receives an image of the sample rack 100 from the camera 202.

At step 504, the processor 408 obtains data associated with each barcode 104 from the received image.

Obtaining the data may involve the processor 408 of the image capture device 400 analysing the image to extract the associated data. Alternatively, the processor 400 may transmit the image to the separate host computer mentioned above. In this case the host computer may analyse the image to extract the data, then transmit the data back to the processor 408.

For example, the processor 408 may extract data identifying the contents of each sample holder 102 from the individual barcode 104 thereon, and/or data recording the position of each sample holder 102 within the sample rack 100.

At step 506, the processor 408 establishes communication with the RFID tag 402 via the RFID reader/writer. The RFID reader/writer may, for example, communicate with the RFID tag 402 using NFC.

In between step 506 and 508, the processor 408 may compress the data extracted from the image. This allows the most efficient use of the memory of the RFID tag 402, and increases the speed of memory read and write operations.

Additionally, the processor 408 may add metadata to accompany the data extracted from the image. For example, the processor 408 may add a record of the time at which the image was captured.

At step 508, the processor 408 transmits the information extracted from the barcodes 104 to the RFID tag 402 using the RFID reader/writer. The information is stored on the RFID tag 402 along with any metadata added by the processor 408.

Once this process has been carried out, the RFID tag 402 may, for example, store a full record of the samples contained in each sample holder 102, together with the location of each sample holder 102 within the sample rack 100. Anyone wishing to e.g. check where a particular sample may be found may then retrieve this information from the RFID tag 402, for example using a handheld scanning device as described below, without the need to capture a further image of the barcodes 104. This may be of particular use if, for example, the samples require storage at cryogenic temperatures, and the cold causes frost to form on the sample holders 102 obscuring the barcodes 104.

It is noted that the above process may, if desired, be entirely automated, and may consequently be performed rapidly and with minimal effort by placing the sample rack 100 briefly on the image capture device 400.

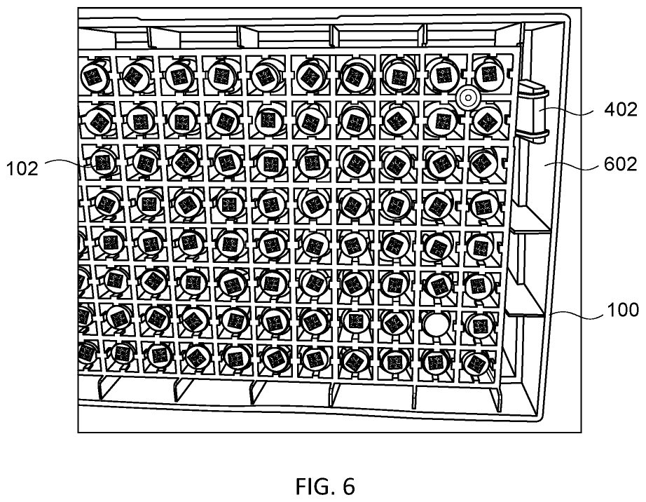

FIG. 6 shows a view of an exemplary sample rack 100 containing sample holders 102, with an RFID tag 402 affixed to the sample rack 100 by means described below.

The RFID tag 402 may have various properties that aid its performance in the above method, especially at cryogenic temperatures or other low temperature ranges.

An RFID tag typically comprises a chip and an antenna. In conventional RFID tags, the two may be joined by a material such as solder. On cooling in liquid nitrogen, differential thermal contraction of this joining material compared to the chip and antenna generally causes the joining material to shatter, breaking the RFID tag and preventing it from being used. This can be prevented by using an RFID tag 402 wherein the chip and antenna are not joined by a joining material, but instead by direct bonding, so that there is no risk of differential thermal contraction. Direct bonding additionally minimises the size of the RFID tag 402. For example, the antenna of the RFID tag 402 may be welded to the chip rather than soldered. The chip may additionally have a large input capacitance to allow the use of a small antenna.

The antenna of the RFID tag may be made of copper or aluminium. The RFID tag may comprise a substrate consisting of epoxy; anti-freezing pads or enclosures may also be used.

To allow sufficient information to be stored on the RFID tag 402 to identify a full rack 100 of sample holders 102, it is advantageous for the RFID tag 402 to use ferroelectric random-access memory (FRAM) storage. In particular, the use of FRAM generally allows the RFID tag 402 to be smaller for a given amount of memory storage. FRAM also features radiation hardness, allowing the RFID tag 402 to be used in medical and healthcare applications that require gamma ray sterilisation, as well as long-term data retention over 10 or more years.

In order to be compatible with industry standard sample racks 100, it may for example be advantageous if the dimensions of the tag are smaller than 12.5 mm by 12.5 mm by 2.5 mm (corresponding to a footprint area of approximately 160 mm²).

As noted above, it is generally advantageous if the RFID tag 402 is able to communicate via NFC.

Given the difficulty in cooling batteries or other power sources to cryogenic temperatures, it may be advantageous for the RFID tag 402 to be passively powered via energy harvesting. For example, the RFID tag 402 may only switch on and begin broadcasting when it receives a signal, such as from the RFID reader/writer.

Additionally, using a passively powered RFID tag 402 minimises the risk of failure arising from voltage spikes that may occur during cooling to cryogenic temperatures. This is because a passively powered RFID tag 402 has a minimal capability to generate significant voltages without receiving an external signal.

In implementing the above method, there is a technical challenge in affixing the RFID tag 402 to the sample rack 100. A straightforward approach would be to use adhesive. However, if the sample rack 100 is to be cooled to cryogenic temperatures, for example using liquid nitrogen, adhesive will not function correctly. This is because the thermal contraction of the adhesive on cooling will be different from the contraction of the sample rack 100 and the RFID tag 402. This generally results in the degradation or shattering of the adhesive and/or damage to the RFID tag 402. Additionally, using adhesive to attach an RFID tag 402 to an existing sample rack 100 that is already in use and already at cryogenic temperature would require the sample rack 100 to be thawed, risking damage to the samples contained therein. It is therefore necessary to affix the RFID tag 402 to the sample rack 100 by a means that does not involve adhesive, and that is resistant to extreme changes in temperature. This issue may be solved by affixing the RFID tag 402 to the sample rack 100 using a mechanical device, in particular an RFID tag clip 700.

FIG. 7 shows an exemplary RFID tag clip 700. The RFID tag clip 700 comprises a deformable member 702 and an RFID tag supporting portion 704.

In the example of FIG. 7, the RFID tag clip 700 comprises a single bent piece of material (such as a metal, e.g. stainless steel). In this example, the deformable member 702 may consist of a piece of metal bent into a V-shape, for example at a 45-degree angle, while the RFID tag supporting portion 704 may consist of a piece of metal bent into a U-shape to define a slot for accepting the RFID tag 402.

The largest dimension of the RFID tag clip 700 may, for example, be less than 20 mm. In particular, a height H of the slot may be 12 mm, and a length L of the deformable member 702 may be 8 mm. A width W of the slot may be 2.5 mm. A depth D of the RFID tag clip 700 may be 9.5 mm.

Once the RFID tag 402 is inserted into the slot, the RFID tag clip 700 may, for example, be inserted into a recess 602 in the sample rack 100. Such recesses are generally a feature of industry standard sample racks such as ANSI/SLAS and ANSI/SBS footprint racks, as well as cryogenic boxes.

When the RFID tag clip 700 is inserted into the recess 602, the deformable member 702 is compressed to fit within the recess 602. This elastic compression results in an outward force as the deformable member 702 seeks to return to its original position. This force presses out against the walls of the recess 602, mechanically holding the RFID tag 402 in place. In embodiments where the RFID tag clip 700 is made from a single piece of metal, the RFID tag clip 700 is resilient to changes in temperature and can continue to operate during cooling to cryogenic temperatures, or on insertion into an existing sample rack that is already at cryogenic temperature.

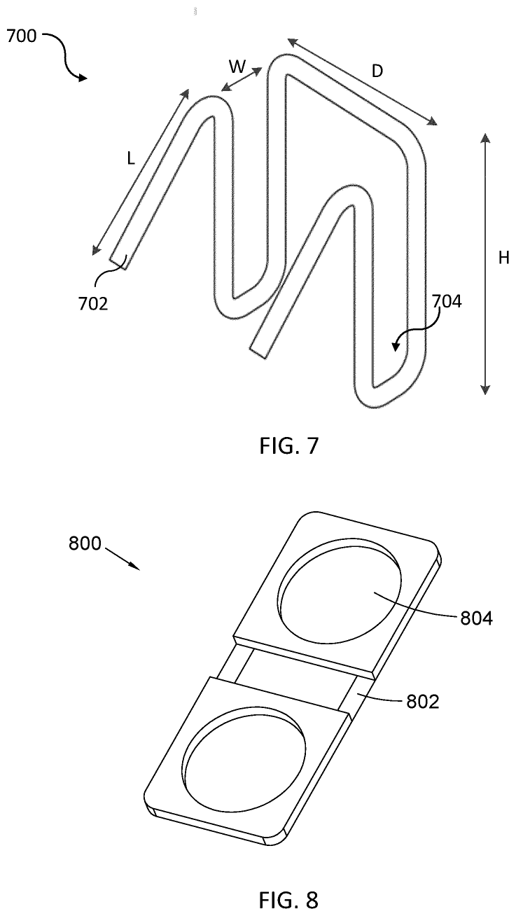

FIG. 8 shows a protective enclosure 800 for the RFID tag 402. The protective enclosure 800 may enclose the RFID tag 402 within the RIFD tag supporting portion 704 of the RFID tag clip 700, and may further enclose a protective material that surrounds the RFID tag. For example, the further material may provide enhanced thermal insulation or mechanical protection. The protective enclosure 800 may, as illustrated in FIG. 8, be made from a piece of material such as a polymer, for example polypropylene. For example, if the sample rack 100 is made of a particular plastic, the protective enclosure 800 may be made of the same plastic. The protective enclosure 800 may comprise a central region 802 that is able to fold, allowing two recesses 804 to close in a book-like motion and accept the RFID tag 402.

The protective enclosure 800 protects the RFID tag 402 from mechanical harm, for example during the process of handling the RFID tag 402 during affixing to the sample rack 100. Additionally, the protective enclosure 800 provides a degree of thermal insulation, so that when the RFID tag 402 is cooled to cryogenic temperatures, the RFID tag 402 cools more slowly than the ambient environment. This reduces the risk of the RFID tag 402 being damaged by a rapid change in temperature, for example due to hot carrier induced degradation of MOSFET components within the RFID tag 402.

The protective enclosure 800 also offers protection against spilled or splashed chemicals that may otherwise impact directly on the RFID tag 402.

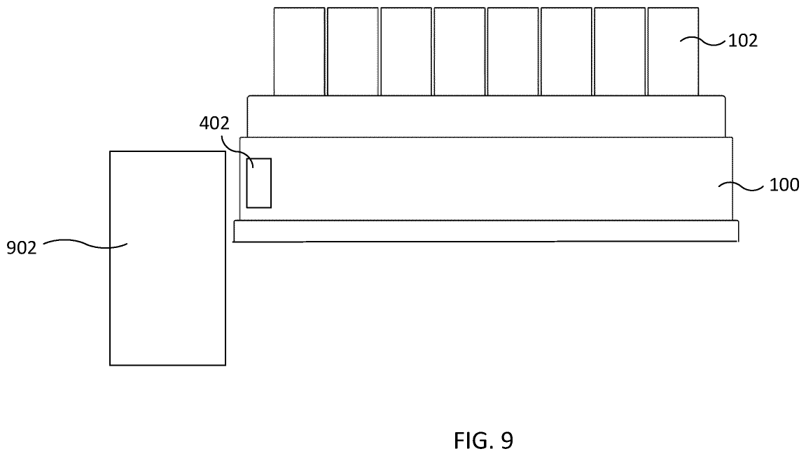

FIG. 9 illustrates the use of a handheld scanning device 902 to retrieve information stored on the RFID tag 402. The handheld scanning device 902 may be a purpose-built device, or may for example be a mobile communications device (e.g. a mobile phone or tablet) running a scanning application.

The handheld scanning device 902 may communicate with the RFID tag 402 by, for example, transmitting a probing signal to the RFID tag 402 and waiting to receive a return signal. Upon receiving a return signal containing data stored on the RFID tag 402, the handheld scanning device 902 may output this data, for example by displaying the data on a screen to a user, or by transmitting the data to another device. In accordance with the methods described above, the data stored on the RFID tag 402 identifies the samples stored in the sample holders 102 within the sample rack 100. The handheld scanning device 902 therefore allows the user to identify what is stored in the sample rack 100 without needing to access the barcodes 104.

The handheld scanning device 902 may further comprise a 2D barcode scanner, in case the user wishes to verify information from the RFID tag 402 by scanning one or more of the barcodes 104. For example, the handheld scanning device 902 may be able to capture an image of one or more, or all of the barcodes 104 and extract information associated with each barcode 104.

The features described above with regard to the RFID reader/writer may also be present in the handheld scanning device 902. For example, the handheld scanning device 902 may make use of a dynamic power output module, automatic antenna tuning, continuous signal level scaling, and/or active wave shaping when communicating with the RFID tag 402.

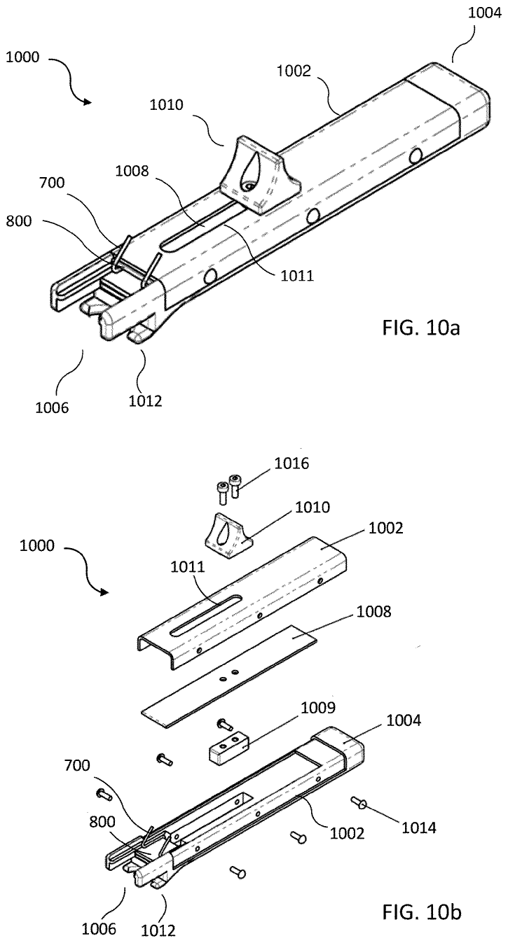

FIG. 10a shows an applicator 1000 that may be used for inserting the RFID tag clip 700 containing the RFID tag 402, optionally in the protective enclosure 800, into the recess 602 of the sample rack 100. The applicator comprises a shaft 1002 for the user to hold, with at least one end 1006 of the applicator 1000 being open. The RFID tag clip 700 may be inserted into the open end 1006 to be dispensed into the recess 602. The RFID tag clip 700 is dispensed by a blade 1008 within a hollow interior of the shaft 1002. The blade 1008 is attached to a knob 1010 external to the shaft 1002, such that a user can move the blade 1008 by pushing the knob 1010.

As shown in the embodiment of FIG. 10a, the knob 1010 may be attached to the blade 1008 via a slot 1011 in a surface of the shaft 1002 (for example, an upper surface). The slot 1011 may define two end positions of the blade 1008, corresponding to the knob 1010 being positioned at one or the other end of the slot 1011. When the user pushes the knob 1010 to the end of the slot 1011 furthest from the open end 1006 of the applicator 1000, this may create space for an RFID tag clip 700 to be inserted into the open end 1006. Pushing the knob 1010 to the end of the slot 1011 closest to the open end 1006 may then cause the blade 1008 to push the RFID tag clip 700 out of the open end 1006 of the applicator 1000, thereby dispensing the RFID tag clip 700 from the open end 1006.

In embodiments wherein the RFID tag clip 700 is both inserted into and dispensed from the same open end 1006 of the applicator 1000, the end 1004 of the applicator that opposes the open end 1006 may be closed.

The applicator allows for quicker and easier insertion of the RFID tag clip 700 into the recess 602, and reduces the risk of dropping or otherwise mishandling the RFID tag clip 700 during insertion.

The applicator 1000 further comprises one or more teeth 1012 that can be placed on an edge of the recess 602 to ensure that the open end 1006 is correctly positioned for dispensing the RFID tag 700. For example, as shown in FIGS. 10a and 10b, the applicator 1000 may comprise two teeth 1012. The teeth 1012 allow the user to securely and steadily rest the applicator 1000 in position during insertion. This avoids mistakes arising from, for example, shaking of the user's hand when operating the applicator 1000.

In embodiments wherein the slot 1011 is disposed on an upper surface of the shaft 1002, the teeth 1012 may be disposed on an opposing lower surface, such that when the teeth 1012 are resting on an edge of the recess 602, the knob 1010 is as easy to reach as possible.

FIG. 10b shows an exploded view of the applicator 1000, more clearly showing the blade 1008 contained within the shaft 1002.

It is noted that various components of the applicator 1000 may be attached using screws. For example, in the embodiment of FIG. 10b, there are screws 1016 attaching the knob 1010 to the blade 1008 and a further guide block 1009 to guide the blade 1008 along the slot 1011. Additionally, there are further screws 1014 that form the shaft 1002 from two components. It will be appreciated that alternative means of attachment, such as glue or another adhesive, could be used instead.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

This was supported by UK Research and Innovation—Innovate UK under Grant KTP 104347.

1. A method of storing information from a plurality of sample holders held in a sample rack, each of the sample holders having an individual barcode thereon, wherein there is an RFID tag affixed to the sample rack, the method performed by a processor of an image capture device and comprising:
receiving an image of the barcodes from at least one camera of the image capture device;
obtaining data associated with each barcode based on the image;
establishing communication with the RFID tag via an RFID reader/writer of the image capture device; and
transmitting, via the RFID reader/writer, the data associated with each barcode to the RFID tag for storage thereon.

2. The method of claim 1, wherein obtaining data associated with each barcode comprises analysing the image to extract the data.

3. The method of claim 1, wherein obtaining data associated with each barcode comprises:
transmitting the image to a host computer; and
receiving the data from the host computer.

4. The method of claim 1, wherein the RFID reader/writer communicates with the RFID tag via near-field communication (NFC).

5. The method of claim 1, further comprising compressing the data associated with each barcode prior to said transmitting.

6. The method of claim 1, wherein the data associated with each barcode comprises a unique identifier of each sample holder.

7. The method of claim 1, wherein the data associated with each barcode comprises a location of each sample holder within the sample rack.

8. The method of claim 1, further comprising adding metadata to the data associated with each barcode prior to said transmitting, such that the metadata and the data are stored on the RFID tag.

9. (canceled)

10. The method of claim 1, further comprising using a handheld scanning device to read the data from the RFID tag.

11. An image capture device for storing information from a plurality of sample holders held in a sample rack, each of the sample holders having an individual barcode thereon, wherein there is an RFID tag affixed to the sample rack, the image capture device comprising:
at least one camera configured to capture an image of the sample rack;
an RFID reader/writer configured to establish communication with the RFID tag; and
a processor configured to obtain data associated with each barcode based on the image, and transmit the data, via the RFID reader/writer, to the RFID tag for storage thereon.

12. The image capture device of claim 11, wherein the processor is configured to obtain the data by analysing the image to extract the data, or by transmitting the image to a host computer and receiving the data from the host computer.

13. (canceled)

14. The image capture device of claim 11, further comprising an enclosure comprising a transparent window which, in use, is adjacent to the sample holder rack.

15. (canceled)

16. The image capture device of claim 14, further comprising a lighting arrangement mounted within the enclosure, the lighting arrangement comprising at least one light source to illuminate the sample rack through the transparent window.

17. The image capture device of claim 14 , further comprising a mirror in an optical path between the at least one camera and the transparent window, the mirror arranged to relay light rays reflecting from the sample rack to the at least one camera.

18. The image capture device of claim 17, wherein the camera, the lighting arrangement, and the mirror are non-moveable.

19. The image capture device of claim 11, further comprising a 1D barcode scanner operable to read a 1D barcode on the sample rack, wherein the 1D barcode identifies the sample rack.

20. The image capture device of claim 11, wherein the RFID reader/writer comprises an antenna positioned such that, in use, the antenna is adjacent to the RFID tag.

21. The image capture device of claim 20, wherein the RFID reader/writer comprises a power regulator to automatically adapt a power output of the antenna via dynamic power output, a noise suppression receiver to implement continuous signal level scaling, an active wave shaping switch, or one or more further antennas.

22. The image capture device of claim 20, wherein the RFID reader/writer is further configured to control a transmission frequency of the antenna by using one or more variable capacitors to implement automatic antenna tuning.

23-25. (canceled)

26. A computer program product for storing information from a plurality of sample holders held in a sample rack, each of the sample holders having an individual barcode thereon, wherein there is an RFID tag affixed to the sample rack, the computer program product comprising code embodied on a computer readable medium and configured so as when executed on the processor of the image capture device to perform the method of claim 1.

27-73. (canceled)
